(19) United States
(12) Patent Application Publication
(10) Pub. No.: US 2017/0102332 A1
(43) Pub. Date: Apr. 13, 2017

(54) CHEMICALLY SWITCHABLE ULTRAVIOLET PHOTOLUMINESCENCE

(71) Applicants: Drexel University, Philadelphia, PA (US); The Trustees Of The University of Pennsylvania, Philadelphia, PA (US)

(72) Inventors: Jonathan E. SPANIER, Bala Cynwyd, PA (US); Zongquan GU, Chalfont, PA (US); Mohammad A. ISLAM, Broomall, PA (US); Diomedes SALDANA-GRECO, Philadelphia, PA (US); Andrew Marshall RAPPE, Penn Valley, PA (US)

(21) Appl. No.: 15/128,149

(22) PCT Filed: Mar. 23, 2015
(86) PCT No.: PCT/US2015/021983

§ 371 Date: Sep. 22, 2016

Related U.S. Application Data
(60) Provisional application No. 61/970,649, filed on Mar. 26, 2014.

(51) Int. Cl. G01N 21/64; G01N 21/76

(52) U.S. Cl. CPC G01N 21/6489; G01N 21/76; G01N 2021/7786

(57) ABSTRACT

The present disclosure pertains to the use of intense, narrow-linewidth surface, chemically-switchable ultraviolet photoluminescence from radiative recombination of the two-dimensional electron liquid with photo-excited holes in complex oxide heterostructures, such as LaAlO₃/SrTiO₃ (LAO/STO). Such photoluminescence from the interface between the upper and lower layers can be suppressed and restored reversibly under oxidizing and reducing conditions, respectively, as induced by chemisorption and reversal of chemisorption on the exposed surface of the heterostructure's upper member. Making use of this chemically-switchable ultraviolet photoluminescence, the present disclosure provides, inter alia, systems for detection of a chemical species, methods for determining the absence or presence of a chemical species in a sample, optoelectronic devices, and methods for producing optoelectronic devices.

### CROSS-REFERENCE TO RELATED APPLICATIONS

This application claims priority to U.S. Provisional Application No. 61/970,549, filed Mar. 26, 2014, the entire contents of which are incorporated herein by reference.

### GOVERNMENT RIGHTS

The subject matter disclosed herein was made with government support under award/contract/grant number NSF DMR 1124696, awarded by the U.S. National Science Foundation. The Government has certain rights in the herein disclosed subject matter.

### TECHNICAL FIELD

The present disclosure relates to systems and methods for producing chemisorption-induced ultraviolet photoluminescence.

### BACKGROUND

Conventional light-emitting semiconductor quantum wells are ubiquitous in optoelectronics for encoding, manipulating, carrying and conveying information. The discovery of high-mobility conduction (Ohtomo, 2004) and correlated electronic phase behavior (Dagotto, 2005; Reyren, 2007; Hwang, 2011; Mannhart, 2011) at the interface between band insulators LaAlO₃ and SrTiO₃ offers prospects for novel, all-oxide electronics.

Symmetry breaking and chemical potential mismatch between constituent materials at an interface or a surface result in novel phenomena inaccessible in the bulk. These phenomena can be tuned extensively, since a surface, and to some extent, an interface, is free to reconstruct structurally and electronically. For example, discovery of high-mobility conduction (Ohtomo, 2004), ferromagnetism and superconductivity (Dagotto, 2005; Reyren, 2007; Hwang, 2011; Mannhart, 2011) at the interface between band insulators LaAlO₃ (LAO) and SrTiO₃ (STO) offers prospects for novel, all-oxide electronics. These prospects are advanced by local and reversible manipulation of an insulator-to-metal (IM) transition and conductance (Cen, 2010) and photodetection (Irvin, 2010), promising reconfigurable nanoscale oxide electronics through local surface chemical control (Cen, 2009).

Electronic correlations of the oxide lattice drive a host of distinctive features and properties of the two-dimensional electron liquid (2DEL) at complex oxide heterostructure interfaces (Hwang, 2011; Mannhart, 2011). Among these, and distinct from two-dimensional carrier gases in conventional semiconductors, is the occurrence of multiple quantum wells each spaced by the TiO₆ octahedral distance (Breitschaft, 2010) in addition to a contribution from band bending. Since transport measurements involve electrons near the Fermi level (E_{F}), observation of tunneling conductances is limited to probing unoccupied states (≧E_{F}).

The search persists for novel nanoscale oxide optoelectronic systems and devices that are enabled by the distinctive properties of the two-dimensional electron liquid at complex oxide heterostructure interfaces.

### SUMMARY

Disclosed are systems for detection of a chemical species comprising a complex oxide heterostructure comprising an upper member having an exposed surface, a lower member, and an interface between the upper and lower members, wherein chemisorption of the chemical species at the exposed surface of the upper member produces ultraviolet photoluminescence at the interface between the upper and lower members, and wherein the upper member has a thickness of up to about 30 unit cells; and, a sensor for determining the absence or presence of ultraviolet photoluminescence at the interface.

Also disclosed are methods for determining the absence or presence of a chemical species in a sample comprising providing a complex oxide heterostructure comprising an upper member having an exposed surface, a lower member, and an interface between the upper and lower members, wherein chemisorption of the chemical species at the exposed surface of the upper member produces ultraviolet photoluminescence at the interface between the upper and lower members, and wherein the upper member has a thickness of up to about 30 unit cells; contacting the exposed surface of the upper member of the heterostructure with the sample; and, determining whether the interface between the upper and lower members produces ultraviolet photoluminescence following the contacting step.

The present disclosure also relates to optoelectronic devices that comprise a complex oxide heterostructure comprising an upper member having an exposed surface, a lower member, and an interface between the upper and lower members, wherein the upper member has a thickness of up to about 30 unit cells; and, a plurality of individual members of a chemical species that is chemisorbed in a patterned array on the exposed surface of the upper member, wherein the chemisorption of each member of the chemical species at the exposed surface produces ultraviolet photoluminescence at a location of the interface that corresponds to the spatial location of each member on the exposed surface. In addition, the present disclosure concerns a plurality of such optoelectronic devices that encodes information when the ultraviolet photoluminescence at the interface of each respective device is read in series.

Also disclosed are methods for producing an optoelectronic device comprising: providing a complex oxide heterostructure comprising an upper member having an exposed surface, a lower member, and an interface between the upper and lower members, wherein the upper member has a thickness of up to about 30 unit cells; chemisorbing a plurality of individual members of a chemical species in a patterned array on said exposed surface of the upper member, wherein the chemisorption of a member of the chemical species at the exposed surface produces ultraviolet photoluminescence at a location of the interface that corresponds to the spatial location of the member on the exposed surface.

### BRIEF DESCRIPTION OF THE DRAWINGS

FIG. 1 provides a schematic illustration of surface chemically-switched sub-surface quantum well-based ultraviolet (UV) photoluminescence (PL) showing laser-excited (a) blue PL emitting from STO substrate underneath AlO₂-terminated 10 u.c. LAO film, and (b) UV PL emitting from the complex oxide heterostructure quantum well interface under identical excitation, but following chemisorption of protons resulting in electron transfer to the LAO/STO interface. (c) Layer-resolved electronic density of states (DOS) for bare LAO/STO} undergoing the polar catastrophe which yields the transfer of ½ electrons (in the thick film limit) from the AlO₂ surface of the LAO film to the LAO/STO interface, with the blue line indicating the potential build up. (d) Layer-resolved DOS for chemisorption of H⁺ onto AlO₂/LAO/STO. The H atom transfers charge to the LAO/STO system at equilibrium, eliminating the potential build up and opening an energy gap so that optical transitions can be accessible, indicated by the grey shaded area. (e) PL from a pristine (P) 10 u.c. LAO/STO system shows a broad feature (˜2.8 eV) attributed to recombination involving O vacancies. When the sample is exposed to water vapor in situ under vacuum, 300K PL remains broad (black trace). Significantly, intense UV PL peaks emerge at 4.2K (red trace). Peaks denoted 2D₁ and 2D₂ (inset) are assigned to different 2D quantized electron energy level recombination with free holes. Peaks denoted zone boundary edge (BE⁻, and BE⁺, inset) are assigned to phonon-assisted interband transitions in STO. (f) reversibility of PL from a single 10 u.c. LAO/STO film heterostructure as found (left), following H⁺ passivation (center), and after annealing in O₂ and desorption of H⁺ (right), each collected at 4.2K.

FIG. 2 concerns investigations of the influence of H⁺ on electronic structure. (a) DFT calculated electronic band structure of H surface chemisorbed LAO/STO showing a large valence-conduction band gap. (b) Left panel: enlarged view of the conduction states in the blue box in a; right panel: the projected DOS shows the contribution from the Ti 3d_{xy} orbitals in the layers near the interface. The horizontal line at zero on the y-axis indicates E_{F}. (c) Electron distribution of the conduction states. The atomic structure at the top of the graph shows a charge density isosurface for all the states within 0.5 eV below E_{F}, which consists of n=4 bands. The graph below shows the planar-averaged filled state density of the conduction bands. The inset shows that the conduction electrons are strongly localized in Ti 3d_{xy} orbitals. (d) Self consistent Poisson-Schrodinger model calculations show (inset) that passivation of AlO₂-terminated LAO/STO by H⁺ results in flattening of the conduction (solid green) and valence (solid blue) bands in LAO (0<z<4 nm) compared with the bound potential (dashed green and blue, respectively) induced by surface proton, AlO₂ and LaO, consistent with the DFT results in FIGS. 1(c) and 1(d)). Band bending (green), bound eigenstates (horizontal blue), and the modulus of the electronic eigenfunctions (blue) are shown and contribute to observed 2DEL-photoexcited hole PL.

FIG. 3 depicts quenching, thermal activation and saturation of 2DEL-photoexcited hole PL, and chemically-switched UV PL in STO. (a) Temperature evolution of the PL from 10 u.c. LAO/STO. Shown in the inset are the integrated intensities of the 2DEL and BE⁻ peaks plotted as functions of 1/kT. Unlike the phonon-assisted PL peak, which decreases for decreasing T, cooling-induced onset and rise of the 2DEL peak is observed, followed by its saturation at lower T. This is a signature of the onset of spatial confinement of carriers, as found in classic III-V and III-N semiconductor heterojunction 2DEGs. Shown in the inset are the temperature dependences of the PL peak integrated areas. (b) 300K and 4.2K from pristine (“dry”), and temperature dependence of PL from H⁺-chemisorbed STO, and (c), comparison of the 4.2K PL spectrum of the H⁺-passivated STO with that for the H⁺-passivated 10 u.c. LAO/STO. The PL spectrum from the H⁺-passivated STO has been multiplied by 100 for comparison.

FIGS. 4(a)-(c) depicts RHEED intensity evolution with film thickness for different laser fluence as labeled. FIG. 4(d) shows the RHEED image. FIG. 4(e) provides AFM topographic height image of grown film. FIG. 4(f) depicts the variation in sheet resistance versus T for different laser fluence energies.

FIG. 5 shows the Gibbs Free Energy of H⁺ and ⁻OH ions chemisorption in LAO/STO showing relative stability of the former ion compared to the latter.

In FIG. 6, top panel (a) shows the atomic structures of relaxed n=2,4,6 LAOn/STO low temperature slabs. FIG. 6(b) shows the electronic band structure of the respective atomic structure in (a). The insulator to metal transition takes place when the LAO unit cells thickness is above 4 unit cells. These are obtained from LDA calculations.

FIG. 7 illustrates the relaxed atomic structures of (a) HO-LAO/STO and (c) H2O-LAO/STO slabs. Their electronic band structures are shown underneath each structure in (b) and (d), respectively. The Fermi energy level is shown with a red line. These are obtained from LDA+U calculations.

FIG. 8 illustrates the DFT average energy levels of the five conducting bands illustrating qualitatively the energy splittings between bands. The black dashed line shows the photoexcited hole and the solid black lines i and j indicate the optical transition for the recombination of the 2DEL quantized level n=1 and n=4 with the photoexcited hole.

FIG. 9 depicts the calculated free charge density as a function of position at and near the LAO/STO interface for the unpassivated (black) and that arising from the H+-terminated AlO₂ (red). Inset: assumed bound charge density as a function of position across the 10 u.c. LAO layer, showing charge associated with chemisorbed H⁺, and alternating AlO₂ and LaO layers.

FIG. 10 shows a series of PL spectra collected from 10 u.c. LAO/STO using different laser intensities using a fixed beam diameter. Top inset: ratio of the 2D1 to BE⁻ integrated intensities as a function of incident laser power; bottom inset: integrated intensity of the 2D1 and BE⁻ photoluminescence peaks with temperature, showing the different variation in photoluminescence intensity with pump intensity.

FIG. 11 depicts the blue-shifting of fitted 2D 1 and BE⁻ peak positions collected from 10 u.c. LAO/STO with temperature.

### DETAILED DESCRIPTION OF ILLUSTRATIVE EMBODIMENTS

The present inventions may be understood more readily by reference to the following detailed description taken in connection with the accompanying figures and examples, which form a part of this disclosure. It is to be understood that these inventions are not limited to the specific products, methods, conditions or parameters described and/or shown herein, and that the terminology used herein is for the purpose of describing particular embodiments by way of example only and is not intended to be limiting of the claimed inventions.

In the present disclosure the singular forms “a,” “an,” and “the” include the plural reference, and reference to a particular numerical value includes at least that particular value, unless the context clearly indicates otherwise. Thus, for example, a reference to “a material” may be a reference to one or more of such materials and equivalents thereof known to those skilled in the art, and so forth. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless otherwise specified, any component, element, attribute, or step that is disclosed with respect to one embodiment of the present methods and products may apply to any other method or product that is disclosed herein.

The disclosures of each patent, patent application, and publication cited or described in this document are hereby incorporated herein by reference, in their entirety.

The present disclosure pertains, inter alia, to the discovery of intense, narrow-linewidth surface, chemically-switchable ultraviolet photoluminescence from radiative recombination of the two-dimensional electron liquid with photo-excited holes in complex oxide heterostructures, such as LaAlO₃/SrTiO₃ (LAO/STO). Complex oxide heterostructures are known among those skilled in the art and typically include a substrate, a first or lower layer formed on the substrate, and a second, upper layer formed on the second layer, wherein both members may be, for example, an oxide perovskite. The presently discovered photoluminescence from the interface between the upper and lower layers can be suppressed and restored reversibly under oxidizing and reducing conditions, respectively, induced by chemisorption and reversal of chemisorption on the exposed surface of the heterostructure's upper member. Such mechanism can be attributable to electron transfer-driven mediation of electronic structure from the exposed surface that may be as many as about 30 unit cells away from the atomically abrupt interface. While light emission invites comparison with traditional compound semiconductor heterojunctions, these results and a model description involving interplay of fast electron transfer connecting reversible coupling of adsorption with quantum well luminescence reveals a new paradigm for surface chemically reconfigurable solid-state UV optoelectronics and molecular sensing.

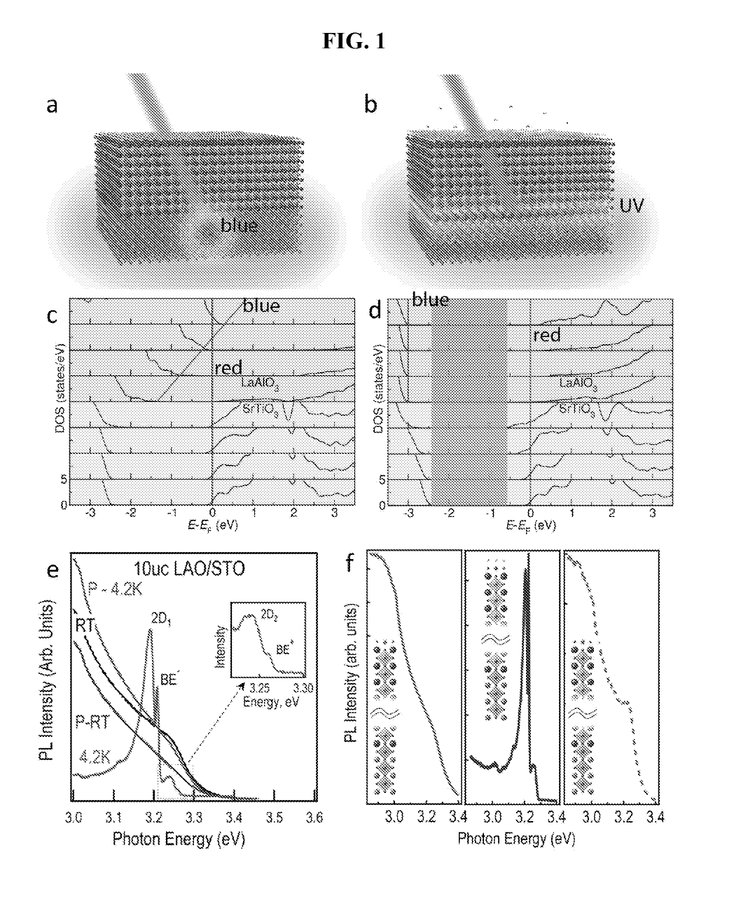

The present disclosure demonstrates, through a combination of photoluminescence spectroscopy, density functional theoretical (DFT) simulations and thermodynamic analyses, how chemisorption-induced manipulation of the interfacial electronic structure reversibly enables and suppresses intense ultraviolet photoluminescence involving radiative recombination of two-dimensionally-confined electrons at the heterostructure interface with photo-excited holes as many as about 30 unit cells away from the surface, as illustrated in FIGS. 1a and 1b.

The well-known polar catastrophe model (Ohtomo, 2004), when described with respect to LAO/STO heterostructures, results in a LAO-thickness-dependent insular-to-metal transition in LAO/STO, with its electronic reconstruction consisting of holes at the surface and electrons at the interface, due to the buildup of potential across LAO. Overlapping conduction and valence bands, internal electric fields within LAO, low 2D electron density (FIG. 1c) in bare LAO/STO, and radiative recombination through O vacancies each contribute to preventing the observation of optical transitions involving the 2DEL. It has been shown that capping the LAO surface with metallic contacts (Arras, 2012; Chan, 2013) or polar solvents (Li, 2013; Xie, 2011) promotes electronic reconstruction and the increase of localized 2D electron density at the LAO/STO interface. However, these strategies may still leave a considerable electric field in LAO or the concentration of O vacancies. Instead, the present disclosure demonstrates that the introduction of certain chemical species, such as water, can lower O vacancy concentration through the adsorption of its dissociation products on AlO₂-terminated LAO (Li, 2012), thereby suppressing radiative recombination through these defects. The presently disclosed DFT calculations indicate that the charge transfer in H-chemisorbed LAO/STO enables the system to reach potential and charge equilibrium, eliminating the average electric field in LAO and raising the 2DEL density in quantized states at the interface. This, in turn, yields accessible transitions in the near UV (FIG. 1d).

A series of low-temperature photoluminescence measurements supports these predictions. Photoluminescence spectra collected at 4.2° K from as-grown 10 u.c. LAO/STO samples (described more fully infra) stored at 300° K and atmospheric pressure reveal a broad feature with peak near 2.8 eV, attributed to radiative recombination through O vacancy defect levels (FIG. 1e) (Mochizuki, 2005; Kalabukhov, 2005; Souza, 2012). When the sample is briefly exposed to water vapor in situ under vacuum at 300° K, photoluminescence collected at 300° K (FIG. 1e) remains broad. However, 4.2° K photoluminescence from identical samples collected immediately following brief exposure to water vapor while under vacuum possesses sharp, UV features (FIG. 1e), and nearly complete suppression of the broad lower-energy emission. Remarkably, the original broad 2.8 eV-centered PL can be recovered through ex situ O₂ annealing (FIG. 1f); subsequent exposure to water in situ produces the identical sharp, higher-energy photoluminescence features and suppresses the broad lower energy emission reproducibly in each sample tested.

Peaks at 3.209 and 3.261 eV (BE⁻ and BE⁺, respectively) are assigned to interband optical transitions involving transverse optical phonon (ω_{TO}=26 meV) emission E_{g}−ω_{TO} and absorption E_{g}+ω_{TO} via the Brillouin zone boundary (Yamada, 2013; Gervais, 1993). Phonon-assisted photoluminescence is commonly seen in indirect band gap materials like STO, and the absence of excitons is consistent with its unusually high dielectric constant (˜10,000 at 4.2° K) (Neville, 1972). The E_{g} of the STO samples was therefore estimated to be 3.235 eV at 4.2° K, in agreement with previous reports (Longo, 2008; Longo, 2010; Orhan, 2004; Zollner, 2000). It is proposed, however, that the peaks centered at 3.192 and 3.240 eV (2D₁ and 2D₂, respectively, FIG. 1c), originate from radiative recombination of 2DEL electrons in the heterostructure with photo-excited holes.

The emergent optical transitions are controlled by fast dynamics in the tested surface chemical environment. H₂O molecules spontaneously dissociate into H⁺ and ⁻OH when the AlO₂-terminated LAO/STO system is exposed to water vapor, enabling the “water-cycle” mechanism (Levy, 2010). The dissociated H₂O components can diffuse and influence the surface environment. Specifically, the dissociated ⁻OH can fill a surface O vacancy and become an adsorbed H, reducing number of O vacancies. However, dissociated H⁺ has lower diffusion barriers than ⁻OH (Li, 2012), leading to large surface regions populated mainly by H⁺. The ab initio thermodynamic stability analysis of surfaces covered with either ⁻OH or H⁺ shows that the H-chemisorbed system is much more thermodynamically stable than the ⁻OH-chemisorbed system (FIG. 5).

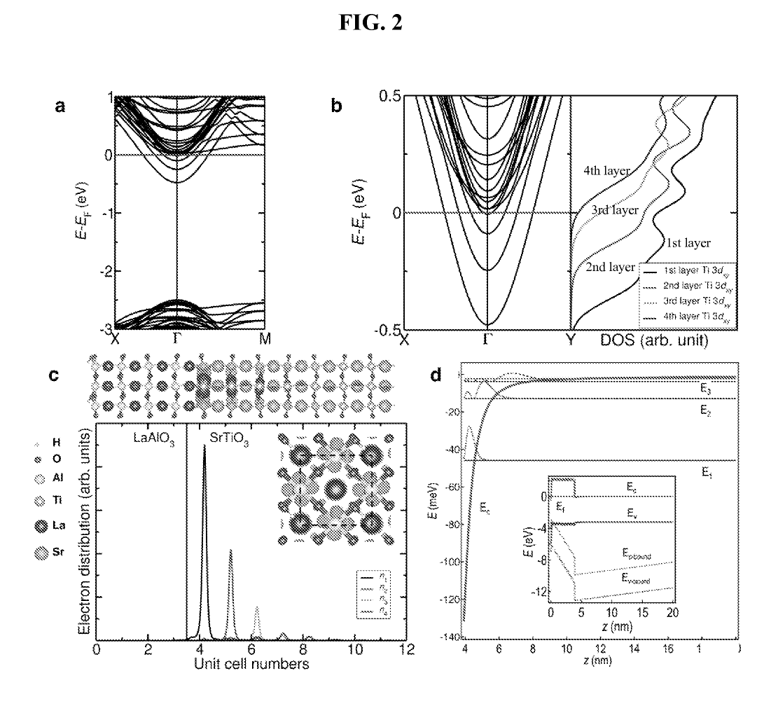

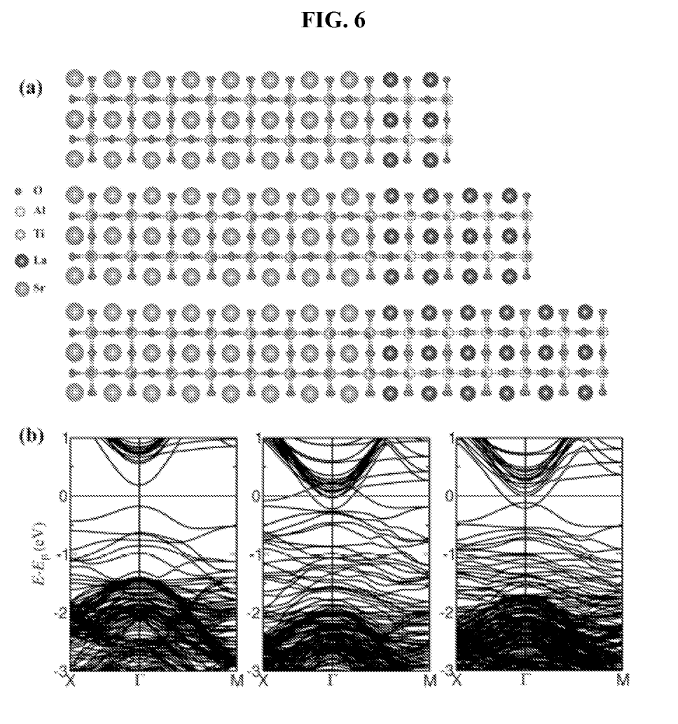

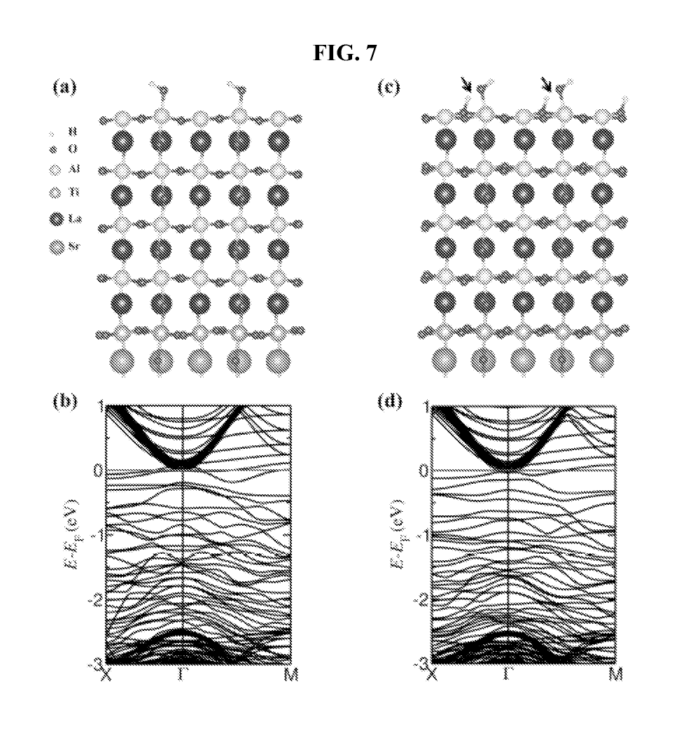

Previous work on H-chemisorbed-LAO/STO indicates that the most stable coverage is one H per two surface unit cells (Son, 2010), and the present DFT+U (Anisimov, 1997) calculations (FIG. 1b) show that this coverage leads to full elimination of the potential buildup. The calculated electronic structures for the four-layer LAO/eight-layer STO(001) system with chemisorbed H₂O and ⁻OH show typical metallic features, similar to bare LAO/STO (FIGS. 6 and 7); however, the H-chemisorbed system is strikingly different. The electronic structure of the H-chemisorbed LAO/STO system differs from that of the bare system due to complete passivation of the surface charge. This occurs via electron transfer from the surface chemisorbed H to the interface, removing the “polar catastrophe”. Cancellation of the potential build up in LAO opens a gap (shaded grey area, FIG. 1d), and states within the first few STO unit cells (FIG. 2a) of the interface are occupied. These states give a higher 2DEL density at the interface making available strong optical transitions, as observed experimentally (FIG. 1e). Though underestimated by DFT+U, the calculated E_{g}˜2.1 eV (FIG. 2a), taken together with the resulting high electron density, indicate that sharp radiative band-to-band transitions are due to H chemisorption.

Ultraviolet photoluminescence features arise from radiative recombination of electrons in quantized states with photoexcited holes. The present DFT calculations predict strongly localized 2DEL conducting bands below E_{F} (FIG. 2a, dashed box). These states mainly arise from Ti 3d_{xy} orbitals at and near the interface (FIG. 2b). Space-resolved electron distribution of these conducting states clearly shows that the 2DEL is distributed into four STO unit cells, strongly localized at the TiO₂ layers, and lower density farther from the LAO interface (FIG. 2c). These features indicate that the 2DEL does not merely involve one confining potential from the interfacial band bending, but has significant contributions from multiple quantum wells each spaced by an oxygen octahedral distance.

To analyze further the 2DEL-derived photoluminescence features, the present inventors evaluated how chemisorption of H⁺ on AlO₂ surfaces of LaAlO₃ alters the conduction and valence bands at and near the LAO/STO interface and induces changes in electron density, band bending, and formation of quantized 2D sub-bands at and near the interface. Self-consistent solutions of the coupled Poisson-Schrödinger (PS) equations (Examples, infra) including a band-bending (King, 2008; Biscaras, 2012) reveal H⁺ chemisorption-induced flattening of the potential gradient across the LAO layer, and that the calculated n=1 level is 42 meV below the bulk band edge, in excellent agreement with our measured value of 43 meV (FIGS. 1e and 1f).

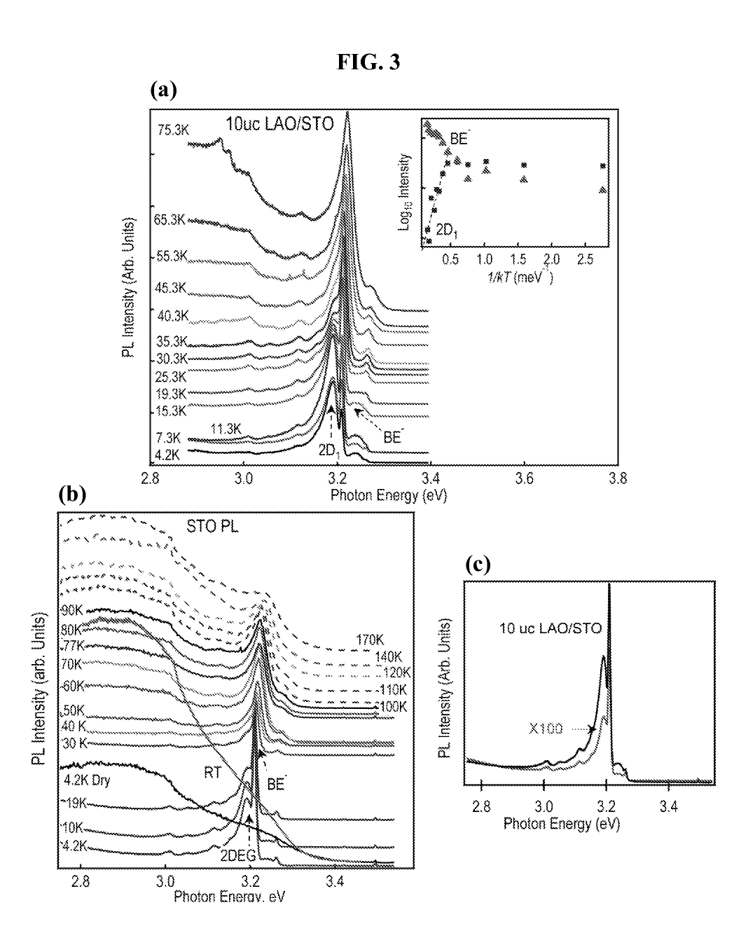

A distinctive signature of the two-dimensional origin of the photoluminescence is saturation of 2DEL photoluminescence intensity at low T followed by thermally-activated quenching at higher T (Bergman, 1996; Shen, 2000; Luo, 2001). The LAO/STO 2DEL photoluminescence can be discerned in the obtained spectra beginning at ˜65 K (FIG. 3). Its intensity rises for decreasing T with an activation energy of 8.06 meV, saturating at ˜23 K, below which it is roughly constant (FIG. 3, inset). This activation and saturation signify thermally-induced leakage of a critical density of carriers out of the interfacial quantum well into the bulk, and a 2D electron-photoexcited hole radiative recombination rate that exceeds the rate of carrier leakage, respectively. In stark contrast, the intensities of the phonon-mediated photoluminescence peaks (BE⁻, BE⁺) exhibit a steady rise with T and are well discerned for T>200 K (FIG. 3, top).

In contrast to III-V compound semiconductors and their heterojunctions for which dE_{g}/dT<0, the 2D₁ and BE⁻ peaks shift to higher energy with T (FIG. 9), consistent with reports of photoluminescence in STO (Yamada, 2010). Oxygen vacancies particularly at and near the surface and LAO/STO interface contribute charge, band bending, and formation of bound states near the interface. As T rises, thermal ionization of electrons bound to these charged impurities causes charge to migrate deeper into the bulk of STO. This reduction in charge density results in progressively shallower bound state energies, manifested as a temperature dependent blue shift of the photoluminescence bands.

Comparison of the variations in intensities of phonon replica-mediated (i.e., BE⁻) and 2DEL photoluminescence with incident laser pump power reveals strongly different, superlinear character in each for pump power Pₚᵤₘₚ<0.6 mW and approximately similar linear increases for Pₚᵤₘₚ>0.6 mW (FIG. 9). In the low pump intensity regime the phonon replica-mediated PL is seen to rise with pump intensity considerably faster than that for the 2DEL photoluminescence. Optically-driven radiative emissions such as the BE⁻ peak in indirect band gap STO require phonons. Without being bound to any particular theory of operation, it is proposed that laser pump intensity changes the lattice temperature, accounting for the faster rise in BE⁻ photoluminescence intensity.

An inversion layer is known to form at the STO surface even in the absence of LAO or other complex oxide films, also forming a two dimensional electron gas or liquid (Meevasana, 2011). It was presently found that pristine TiO₂-terminated STO substrates prepared in the same manner as those for LAO film growth and exposed to water vapor in the same manner have photoluminescence at 4.2° K with UV peaks centered at the same photon energies as those seen for the 10 u.c. LAO/STO (FIG. 3, lower left). Although the UV photoluminescence intensity at 4.2° K from water-exposed STO is more than two orders of magnitude weaker than that from LAO/STO (FIG. 3, lower right), for TiO₂-terminated STO the same spectral changes that accompany the process of producing and suppressing with in situ exposure to water vapor and ex situ oxidation are also seen.

Thus, the present inventors have discovered a correlation between the onset of intense UV photoluminescence from complex oxide quantum wells with chemisorption and dissociation of chemical species, as well as the ability to reverse this effect (i.e., to suppress the ultraviolet emission replaced by spectrally broad, blue photoluminescence). This discovery represents a powerful and sensitive new in operando probe of surface molecular adsorption and of competition in excited state lifetimes among quantum wells- and oxygen vacancy-based recombination with photo-excited holes. Further, connection of molecular adsorbates on and resulting electron transfer from complex oxide surfaces with changes in sub-surface interfacial quantum well electronic structure—observable via UV emission involving two dimensionally-confined electrons—provides novel paradigms for sensing and for surface chemically-programmable optoelectronics.

Accordingly, disclosed are systems for detecting a chemical species comprising a complex oxide heterostructure comprising an upper member having an exposed surface, a lower member, and an interface between the upper and lower members, wherein chemisorption of the chemical species at the exposed surface of the upper member produces ultraviolet photoluminescence at the interface between the upper and lower members, and wherein the upper member has a thickness of up to about 30 unit cells; and, a sensor for determining the absence or presence of ultraviolet photoluminescence at the interface.

In the present systems, the upper and lower members may respectively be formed from any complex oxide species, of which many examples are familiar to those of ordinary skill in the art. For example, the upper and lower members may each be an oxide perovskite. In some embodiments, the upper member comprises GdTiO₃, SrVO₃, LaVO₃, SrNbO₃, or LaAlO₃. The lower member may comprise, for example, SrTiO3. The thickness of the lower member may be, for example, about 2 unit cells to about 100 unit cells. The lower member may be formed by deposition on a substrate, such as a silicon substrate, or another simple perovskite (ABO₃ type), complex perovskite such as (La/Sr)(Al/Ta)O₃, or non-perovskite (e.g., MgO) substrate. Alternatively, the lower member may itself be a substrate, such as SrTiO₃. The thickness of the upper member may be up to about 30 unit cells, such as about 1, 2, 3, 4, 5, 10, 12, 15, 17, 20, 22, 25, 27, or 30 unit cells thick.

The chemical species that the present systems can be used to detect may be characterized as any species that is capable of donating up to one-half electron per unit cell of the upper member when chemisorbed onto the exposed surface of the upper member. The chemical species may also or alternatively be characterized as filling an oxygen vacancy on the exposed surface of the upper member. For example, the chemical species may be a molecule containing an alkali or transition metal and at least one cation that results in chemisorption of H+ or another ion in one or more oxidation states on the exposed surface of the upper member. Such ionic moieties may include Na, Mg, K, Ba, Ca, Zr, Nb, V, Cr, Co, Ni, Cu, Zn, Al, Ga, In, or the like.

As used in connection with the presently described systems, a “sensor” may refer to any device, apparatus, or series of devices or apparatuses that can be used to determine the absence or presence, and/or the intensity of ultraviolet photoluminescence at the interface between the upper and lower members of the complex oxide heterostructure. For example, the sensor may include a light source for exciting the possible source of photoluminescence (e.g., a laser), an apparatus for collecting the photoluminescence spectra (such as a monochromator), and a light detection apparatus, such as a photomultiplier tube, for detecting any ultraviolet photoluminescence from the collected spectra. Those of ordinary skill in the art will readily appreciate that various other apparatuses, devices, or series of devices or apparatuses can be used in order to determine the absence or presence, and/or the intensity of ultraviolet photoluminescence at the interface, and the present disclosure should not be interpreted as being limited to any particular mechanism for performing this function. The sensor may further include components that can measure the chemisorption coverage on the exposed surface of the upper member, for example, by correlating the correlating the observed photoluminescence intensity to chemisorption coverage on the exposed surface of the upper member.

Also disclosed are methods for determining the absence or presence of a chemical species in a sample comprising providing a complex oxide heterostructure comprising an upper member having an exposed surface, a lower member, and an interface between the upper and lower members, wherein chemisorption of the chemical species at the exposed surface of the upper member produces ultraviolet photoluminescence at the interface between the upper and lower members, and wherein the upper member has a thickness of up to about 30 unit cells; contacting the exposed surface of the upper member of the heterostructure with the sample; and, determining whether the interface between the upper and lower members produces ultraviolet photoluminescence following the contacting step.

Any of the characteristics of the complex oxide heterostructure that are described with respect to the previously described systems may apply with respect to the complex oxide heterostructures of the presently disclosed methods.

The sample that is assessed for the absence or presence of a chemical species may be a liquid or a gas (including a vapor). The step of contacting the exposed surface of the upper member of the heterostructure with the sample may be carried out by any means that results in physical contact between the sample and the exposed surface of the upper member. The duration of the contacting step may be selected as desired. For example, the duration of the contacting step may be one second, several seconds, a minute, several minutes, 15 minutes, 30 minutes, one hour, multiple hours, 12 hours, 24 hours, 36 hours, 48 hours, or multiple days.

The determination of whether the interface between the upper and lower members produces ultraviolet photoluminescence following the contacting step may include the use of any sensor as described above with respect to the presently disclosed systems.

The present methods may further comprise measuring the intensity of any ultraviolet photoluminescence at the interface between the upper and lower members. The methods may also or alternatively comprise determining the extent of chemisorption coverage on the exposed surface of the upper member, for example, by correlating the correlating the observed photoluminescence intensity to chemisorption coverage on the exposed surface of the upper member.

If the interface does produce any ultraviolet photoluminescence, the instant methods may additionally comprise terminating at least some of the ultraviolet photoluminescence. As disclosed above, the present inventors have discovered that the ultraviolet photoluminescence effect that was observed with respect to complex oxide heterostructures is reversible, i.e., can be alternately induced and terminated as many times as desired. The chemisorption of an individual member of the chemical species at the exposed surface of the complex oxide heterostructure can produce ultraviolet photoluminescence at a location of the interface that corresponds to the spatial location of the individual member of the chemical species on the exposed surface of the upper member of the heterostructure. In accordance with the present methods, ultraviolet photoluminescence can be induced or terminated at one or more discrete locations of the interface, for example, by chemical desorption at the corresponding spatial location of the upper member of the heterostructure. Other methods for terminating the ultraviolet photoluminescence at a desired location include the use of laser light, heat pulses, or photoionization. For example, a probe may be used to deliver a charge (localized voltage pulse) to a desired location on the exposed surface of the upper member in order to transfer a charge to the heterostructure interface and thereby turn off the electronic reconstruction at a location of the interface that spatially corresponds to the location of the exposed surface to which the charge was delivered. Those of ordinary skill in the art will readily appreciate other available techniques for terminating at least some of the ultraviolet photoluminescence at the heterostructure interface.

The present disclosure also relates to optoelectronic devices that comprise a complex oxide heterostructure comprising an upper member having an exposed surface, a lower member, and an interface between the upper and lower members, wherein the upper member has a thickness of up to about 30 unit cells; and, a plurality of individual members of a chemical species that is chemisorbed in a patterned array on the exposed surface of the upper member, wherein the chemisorption of each member of the chemical species at the exposed surface produces ultraviolet photoluminescence at a location of the interface that corresponds to the spatial location of each member on the exposed surface. In addition, the present disclosure concerns a plurality of such optoelectronic devices that encodes information when the ultraviolet photoluminescence at the interface of each respective device is read in series.

Any of the characteristics of the complex oxide heterostructures that are described with respect to the previously described systems may apply with respect to the complex oxide heterostructures of the presently disclosed optoelectronic devices. Furthermore, the present devices may include any of the chemical species that are described above in connection with the instantly disclosed systems.

In accordance with the present devices, one may chemisorb individual members of the chemical species on the exposed surface of the upper member of the heterostructure in any desired pattern. For example, optional patterns can include stripes, patches, geometric or random shapes, numbers or letters, or any combination thereof. For the purpose of creating a pattern, localized chemisorption of an individual member of the chemical species can be accomplished, for example, by scanning, rasterizing or otherwise placing a local probe, such as an atomic force microscope cantilever including an electrically conductive tip, across in a pre-patterned area or on the surface of an oxide film as described above. This may be performed in the presence of an atmosphere (vapor pressure) containing a molecule having a dissociation product (such as, but not limited to H, O, or OH) during application of a voltage to the tip with respect to the substrate or underlying electrical ground, will result in the local chemisorption of one or more species onto the oxide surface. This can be introduced using a sequence of one or more steps to introduce a pattern of chemistorbates, or using one or more other lithographic process to define areas of chemisorbate on the oxide, all resulting in definition of local region(s) in which UV quantum well photoluminescence will be emitted.

When a plurality of optoelectronic devices in accordance with the present disclosure are arranged together, the patterns of the respective devices can encode information that may be revealed by reading the plurality of devices in series (e.g., in an intended order).

Also disclosed are methods for producing an optoelectronic device comprising: providing a complex oxide heterostructure comprising an upper member having an exposed surface, a lower member, and an interface between the upper and lower members, wherein said upper member has a thickness of up to about 30 unit cells; chemisorbing a plurality of individual members of a chemical species in a patterned array on the exposed surface of the upper member, wherein the chemisorption of a member of the chemical species at the exposed surface produces ultraviolet photoluminescence at a location of the interface that corresponds to the spatial location of the member on the exposed surface.

Any of the characteristics of the complex oxide heterostructures that are described with respect to the previously described systems may apply with respect to the complex oxide heterostructures of the presently disclosed methods for producing an optoelectronic device. Furthermore, the devices of the present methods may include any of the chemical species that are described above in connection with the instantly disclosed systems. Additionally, the step of chemisorbing a plurality of individual members of a chemical species in a patterned array on the exposed surface of the upper member of the heterostructure may include any of the techniques described above with respect to the disclosed optoelectronic devices.

Additional details concerning the presently disclosed systems, methods, and devices are provided in the examples below, which are purely exemplary in nature and are not intended to impose limitations on any aspect of the inventive subject matter described above.

### EXAMPLES

### Film Growth

One set of 10 unit cell thick LaAlO₃ films were grown via reflection high-energy electron diffraction (RHEED)-monitored pulsed-laser deposition (PLD) following the procedure reported previously (Breckenfield, 2013). Briefly, the films were grown at a substrate temperature of 750° C. (this temperature refers to the temperature of the Ag-paint used to provide thermal contact between the substrate and the heater plate as measured via pyrometry), in an oxygen pressure of 1×10⁻³ Torr, with a laser repetition rate of 1 Hz, from a single crystal LaAlO₃ (001) target (Crystec, GmbH) on TiO2-terminated SrTiO₃ (001) substrates treated via standard methods. The growth rate for all films was measured to be about 12 pulses/unit cell. The laser fluence during growth was varied between 1.2-2.0 J/cm² by changing the laser spot size from 0.043 cm² to 0.071 cm² while holding the total incident laser energy constant (85 mJ). All growths were completed with the laser focused on the target in an imaging mode. Growths were completed in an on-axis geometry with a target-substrate distance of 6.6 cm. In situ RHEED studies were used to track the evolution of growth modes, establish growth rates for all depositions, and probe the surface structure and quality.

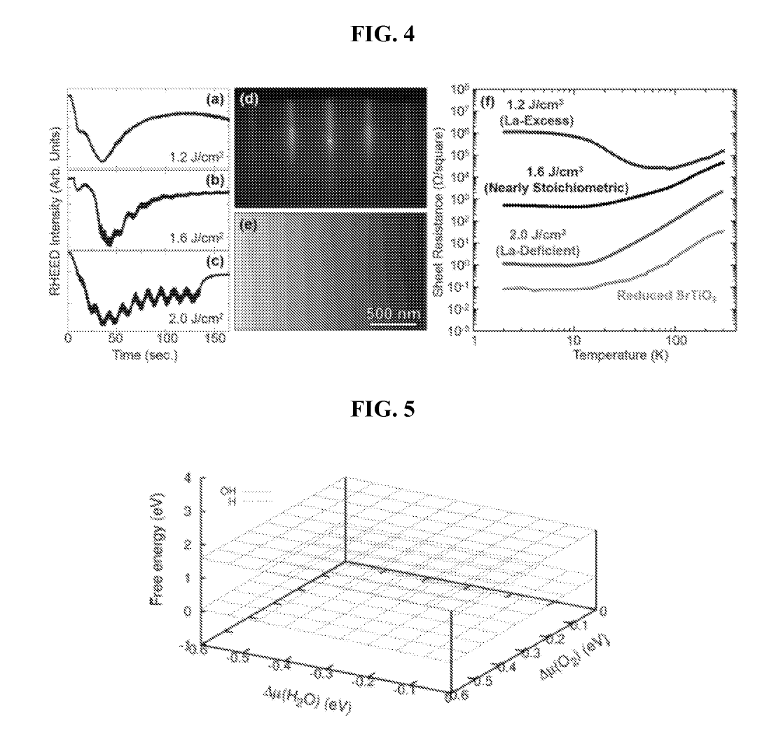

RHEED intensity profiles for 10 unit cell thick films grown at 1.2 (FIG. 4a), 1.6 (FIG. 4b), and 2.0 J/cm² (FIG. 4c) reveal an evolution from step-flow or hybrid-growth to layer-by-layer growth with increasing laser fluence. Typical post-growth RHEED patterns (FIG. 4d) and ex situ atomic force microscopy (AFM) (FIG. 4e) reveal evidence of smooth, atomic-level terraced, island-free films in all cases. While the growth mode varied somewhat with laser fluence, there are no other indications in the RHEED or AFM to suggest significant differences in the films. Subsequent study of the temperature-dependence of resistivity in these films, reveals dramatic changes in sheet resistance and properties. A detailed description of the mechanisms of this change in transport properties are provided elsewhere (Breckenfield, 2013), but it is related to growth induced changes in LaAlO3 stoichiometry that result in the films grown at 1.2, 1.6, and 2.0 J/cm² possessing ˜5% Sr-excess, nearly stoichiometric, and ˜5% Sr-deficient chemistries, respectively.

A second set of LAO/STO samples was prepared using PLD with RHEED. The films were grown at an oxygen pressure of 3×10⁻⁶ torr and a substrate temperature of 720° C. using a single crystal LaAlO₃ target. For the power source, an excimer laser with 0.7 J/cm² energy density and a repetition rate of 1 Hz was used. The sample was cooled at a pressure of 3 ×10⁻⁶ of oxygen. The low growth temperature is necessary because of the low oxygen pressure during the growth: higher growth temperature leads to oxygen loss from the STO substrate. A consequence of the low growth temperature is the delay of strain relaxation in the LAO films to about 20 u.c. The low energy density of the laser pulse was chosen such that stoichiometry can be achieved in the LAO film under the growth conditions.

### Photoluminescence Measurements

PL spectra were collected through a 0.3 m monochromator (Jobin Yvon U1000), dispersed with 1200 grooves/mm gratings, and detected using a water-cooled photomultiplier tube (Hamamatsu). A 325-nm He—Cd laser (Kimmon-Khoa) was used as the excitation source, focused to a spot diameter of 1.15 μm. The incident intensity was in the range of 1-22 W/cm². The samples were mounted in a cryostat (Janis ST-100) and held at 5 ×10⁻⁶ Torr. The vacuum pump and a container of deionized water were simultaneously attached to the cryostat by using a mechanical manifold composed of a T-connector and two diaphragm valves. The sample was pumped down and cooled with the water vapor supply valve closed and the pump valve open. After the cryostat reached its base pressure and desired temperature, the pump valve was closed and the water valve opened for approximately one second and then closed, and the pump was turned off PL data were collected in situ in this configuration. Water vapor was introduced from 300K to 4.2 K through a ¼″ dia. tube.

### DFT Calculations

Plane-wave basis set DFT calculations were performed using the local density approximation (Perdew J P, 1992)+Hubbard U method (LDA+U) (Anisimov V I, 1997) as implemented in the Quantum Espresso (Giannozzi P, 2009) computer code. The U_{eff} parameter (U_{eff}=4.75 eV) for the Ti 3d states was determined by computing the linear response of Ti 3d orbital energy versus occupation number following the scheme previously developed (see Cococcioni and de Gironcoli, 2005). All atoms were represented by norm-conserving, optimized (Rappe A M, 1990), designed nonlocal (Ramer N J, 1999) pseudopotentials generated with the opium package (http://opium.sourceforge.net). The Brillouin zone was sampled using a minimum of 4×4×1 Monkhorst-Pack (Monkhorst H J, 1976) k-point mesh for the slab structures. All calculations were performed with a 50 Ry plane-wave energy cutoff The ionic relaxation parameters were chosen so that the forces in the slab structures were lower than 20 meV/\acute{Å}. The LAO/STO interface was modeled with a supercell slab method. The slabs were separated with about 16 \acute{Å} of vacuum. In this slab model, a dipole correction was added to remove the artificial electric field in the vacuum region.

Thermodynamic Stability Analysis of H⁺ and ⁻OH adsorption at the LAO/STO Surface

It has been observed that water can be dissociated into H⁺ and ⁻OH when it is exposed to AlO₂-terminated surface of LAO/STO (Bi F, 2010). The dissociated components can then be adsorbed and diffuse through the surface. Presently reported is a theoretical thermodynamic stability analysis of AlO₂-terminated surface structure of the LAO/STO system with adsorbates from water dissociation. Density Functional Theory (DFT) calculations were performed to compute the total energy of the bare slab, slab with adsorbates and each of the adsorbate component. The free energies of LAO/STO systems are modeled thermodynamically considering them to be in contact with an atmosphere composed of water vapor components in equilibrium. The surface Gibbs free energy, Ωⁱ, of an individual surface slab, i, is defined as the excess amount of free energy needed to create the surface from its bulk form. In this case, we are treating two surface slabs, Omege^{(H)} and Omega^{(OH)}, with H⁺ and ⁻OH as adsorbates, respectively, and their surface Gibbs free energies are defined as follows:

$${Ω}^{( H )} = \frac{1}{A} [ {G}_{H - LAO / STO} - {G}_{LAO / STO} - {μ}_{H} ]$$

$${Ω}^{( OH )} = \frac{1}{A} [ {G}_{H - LAO / STO} - {G}_{LAO / STO} - {μ}_{H} - {μ}_{O} ]$$

The expressions above are simplified by taking into consideration the following assumptions and approximations:
(1) The Gibbs free energy is approximated to be equal to the DFT energy,

G=Eₜₒₜₐₗ+F_{vib}−TS_{conf}+pV≈Eₜₒₜₐₗ

The energetic contributions provided by the pV and TS_{conf} terms to the thermodynamic stability are considered to be negligible. Also, the term F_{vib}, which is equal to E_{vib}−TS_{vib}, can be computed by the vibrational modes of the system; however, it has been shown for other systems that the phonon frequencies do not vary the order of stable surface phases.
(2) Since water acts as a thermodynamic reservoir, the chemical potentials of H₂O components are not independent; they are related to the chemical potential of H₂O,

μ_{H}_{₂}_{O}=2μ_{H}+μ_{O}
(3) The chemical potential for each component of H₂O is defined as its difference from the total energy of its reference state:

Δμ_{H}_{₂}_{O}=μ_{H}_{₂}_{O}−E_{H}_{₂}_{O}^{gas}

Δμ_{H}=μ_{H}−½E_{H}_{₂}^{gas}

Δμ_{O}=μ_{O}−½E_{O}_{₂}^{gas}

Δμ_{O} can be directly related to T and p(O₂) by the ideal gas approximation, since at equilibrium μ_{O} is equal to the chemical potential of oxygen gas in the environment,

μ_{O}=½μ_{O}_{₂}^{gas}(T,p).

This leads to:

$$Δ {μ}_{O} ( T , p ) = Δ {μ}_{O} ( T , {p}^{0} ) + \frac{1}{2} kT ln ( \frac{p}{{p}^{0}} )$$

where Δμ_{O}(T,p⁰)=½ΔG_{O}_{₂}^{gas}(T,p⁰).

Thermodynamic data from the NIST-JANAF thermochemical tables are used to determine the values of Δμ_{O}(T,p⁰) by selecting the reference state for ½ΔG_{O}_{₂}^{gas}(T,p⁰) at T=0 K and p(O₂)=1 atm.

Based on assumptions and approximations above, the surface free energies are redefined as

$${Ω}^{( H )} = \frac{1}{A} [ {E}_{H - LAO / STO}^{total} - {E}_{LAO / STO}^{total} - \frac{1}{2} ( {E}_{{H}_{2} O}^{total} + Δ {μ}_{{H}_{2} O} ( T , p ) ) + \frac{1}{4} ( {E}_{{O}_{2}}^{total} + Δ {μ}_{{O}_{2}} ( T , p ) ) ]$$

$${Ω}^{( OH )} = \frac{1}{A} [ {E}_{HO - LAO / STO}^{total} - {E}_{LAO / STO}^{total} - \frac{1}{2} ( {E}_{{H}_{2} O}^{total} + Δ {μ}_{{H}_{2} O} ( T , p ) ) + \frac{1}{4} ( {E}_{{O}_{2}}^{total} + Δ {μ}_{{O}_{2}} ( T , p ) ) ]$$

The results of the calculations, shown in FIG. 5, clearly show that the H⁺ ions are significantly more stable on the LAO/STO system compared to ⁻OH ions.

Density Functional Theory calculations of LAO/STO

DFT calculations were performed with plane-wave basis set using both the local density approximation (LDA) (Perdew J P, 1992) and with Hubbard U (LDA+U) (Anisimov V I, 1997) as implemented in the Quantum Espresso (Giannozzi P, 2009) computer code. The LDA+U method, which consists in expanding the LDA energy functional with additional on-site orbital-dependent energy terms, a Hubbard repulsion U and an intratomic Hund's exchange energy J, provides an improved description of electron localization. The spherically averaged form of the rotationally invariant (Dudarev S L, 1998) LDA+U was used with only one effective Hubbard term U_{eff}=U−J, this was determined for the Ti 3d states by linear response (Cococcioni M, 2005) to be U_{eff}=4.75 eV.

The LAO/STO slab structures were designed to model the experimental setup at temperatures below 120 K; therefore, low temperature phases of STO I4/mcm and LAO R³cH with 128 Glazer notations a0a0c+ and a-a-a-, respectively, were used. The LAOn/STO(001) slabs with n=1,2, . . . ,6 LAO unit cells were simulated, while keeping the STO with 8 unit cells. The n-type interface was simulated with TiO2 and LaO layers and the surface was terminated with a AlO2 layer. FIG. 6 shows the relaxed atomic structures of n=2,4,6 LAOn/STO systems and their corresponding band structures. The system starts out semiconducting with the bandgap narrowing with increasing LAO thickness and an insulator to metal transition occurring at 4 unit cells of LAO, in agreement with previous work (Daggotto E, 2005; Ohtomo A, 2004; Reyren N, 2007; Thiel S, 2006).

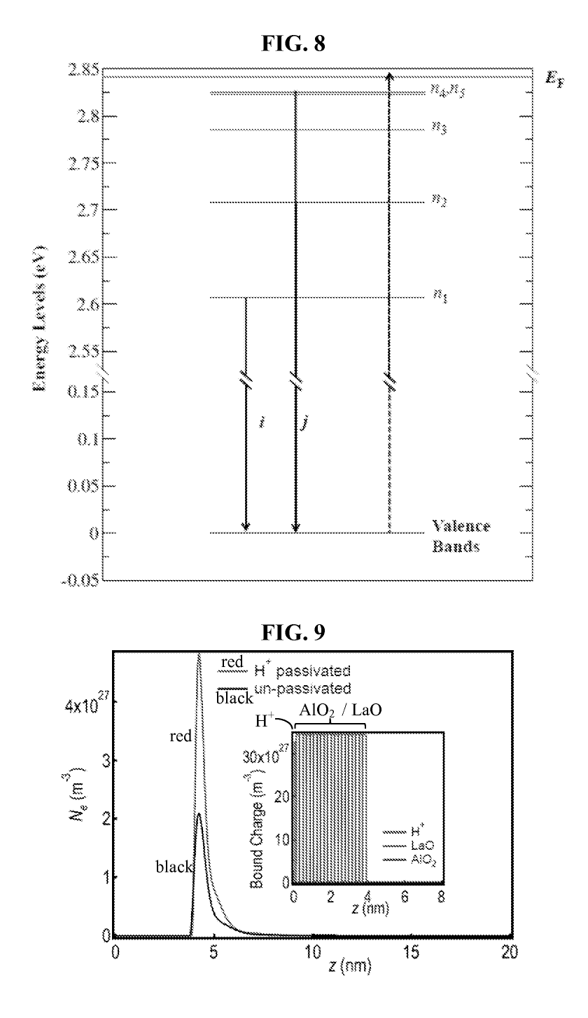

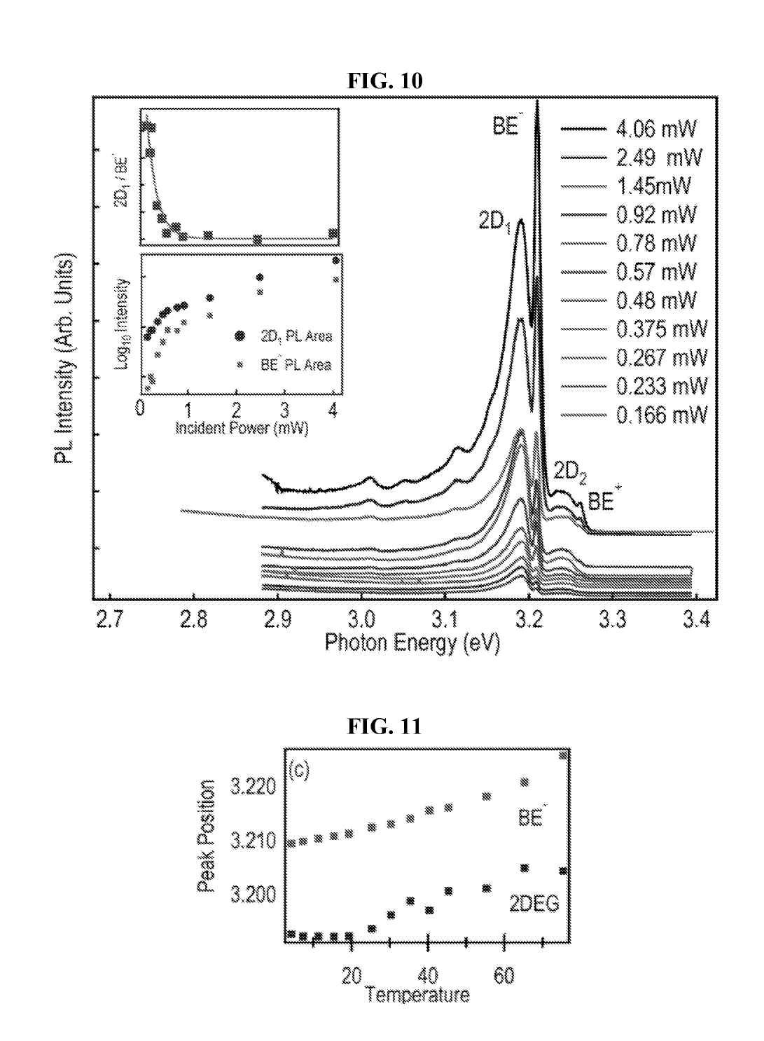

The LAO₄/STO was modeled with H, OH and H₂O chemisorbed at the surface. These systems were constructed within a (\sqrt{2}×\sqrt{2})R45° surface symmetry. The relaxed atomic structures of LAO/STO system with ⁻OH and H₂O adsorbed on the AlO₂-terminated surface are shown in FIGS. 7(a) and 7(c), respectively. FIG. 7(c) shows the spontaneous H₂O dissociation at the surface of the LAO/STO system, since the H chemisorbed to the surface O is ≈1.6 \acute{Å} from the O in the water molecule, indicated by the black arrow. The electronic band structure for each HO-LAO/STO and H₂O-LAO/STO is shown in FIGS. 7(b) and 7(d), respectively. These systems show typical metallic electronic features; neither the isolated 2DEL quantized states nor the split between bands providing access to sharp optical transitions are observed. These features are only achieved by H-chemisorption. For the H-chemisorbed-LAO/STO, the DFT energy level for each of the 2DEL quantized states is averaged over highly dense k-point grid shown in FIG. 8. These average energy levels qualitatively compare to the experimental recombination of each n-bound levels with the photo-excited holes (dashed black line) from the valence bands measured experimentally.

### Self-Consistent Poisson-Schrodinger Model

For quantitative analysis of band bending at the surface (interface) an effective one-electron potential and the corresponding charge carrier density are solved self consistently using the Poisson equation and Schrodinger equation (King P D C, 2008; Biscaras J, 2012; Su S, 2013). Described below is the procedure used for the self-consistent Poisson-Schrodinger method:
(1). A 10 u.c.-thick LAO film on a 100 nm-thick STO substrate is assumed. An initial guess of the band profile is inserted into the Schrodinger equation to solve for the energies and wavefunctions for electrons and holes, respectively, using the Numerov method (Blatt J M, 1967), containing the conduction band EC and the valence band EV, separated by the bandgap Eg-STO=3.2 eV and Eg-LAO=5.6 eV. At the interface, band offset ΔEC and ΔEV are imposed (Pentcheva R, 2008). The effective masses of the electron and the hole are obtained from Santander-Syro A F, 2001 and Pentcheva R, 2010.
(2). The eigenenergies are solved from the Schrodinger equation. In the AlO₂-terminated unpassivated case the Fermi level EF is pinned to satisfy the charge neutrality between electrons and holes using the two-dimensional DOS. In the H⁺-passivated case, charge neutrality is satisfied between the free electrons (one free electron per two unit cells) and surface protons (one proton per two surface unit cells). Next, the sheet carrier density of electrons nₛₛ and holes pₛₛ are found using:

$${n}_{ss} = {\int }_{{E}_{i , e}}^{∞} {DOS}_{e , 2 D} {f}_{FD} ( E ) d E = {\sum }_{i = 1}^{l} {DOS}_{2 D} {f}_{FD} ( {E}_{i , e} , {E}_{f} ) and$$

$${p}_{ss} = {\int }_{{E}_{i , p}}^{∞} {DOS}_{p , 2 D} {f}_{FD} ( E ) d E = {\sum }_{i = 1}^{m} {DOS}_{2 D} {f}_{FD} ( {E}_{i , p} , {E}_{f} )$$

Here DOS_{2D} is the two dimensional density of states and f_{FD}(E) is the Fermi-Dirac distribution function.
(3) The sheet carrier density nₛₛ along with the electron eigenwave functions are then used to determine the volume carrier density Nₑ using

$${N}_{{E}_{i}} = \frac{{n}_{{E}_{i}} {{ψ}_{i} ( z )}^{2}}{δ z}$$

where δz is the resolution, and finally the total volume carrier density is determined from

Nₑ=N_{E}_{_{1,e}}+N_{E}_{_{2,e}}+N_{E}_{_{3,e}}+ . . . N_{E}_{_{l,e}}.

Similar steps are followed to determine the hole volume density Nₚ.
(4) Assuming an ideal interface, the solved Nₑ, Nₚ and the polar layers of LaO and AlO₂ modeled as fixed charges N_{D} and N_{A} are inserted into the Poisson equation to obtain the output band profile. The Poisson equation is represented in the Maxwell-Gauss form since the STO permittivity is electric-field F dependent (Biscaras J, 2012; Neville R C, 1972).

∇·|ε₀εr(F)F|=q[N_{D}−N_{A}−Nₑ(z)+Nₚ(z)]

The limit of integration is the backside of the STO substrate with F=0 since there is no gate voltage applied, and at the interface we impose the condition of continuous electric displacement. The band profiles are thus obtained by integrating F over STO and LAO. In the P—S calculations we assume a clean interface and do not a priori include any defects, impurities and cation intermixing: the contributions to N_{D} and N_{A} are solely from charged layers of LaO and AlO₂ (FIG. 9).
(5) The iteration is carried out using the routine:

E(z)ᵢₙ₋ᵢₜₕ=0.98E(z)ᵢₙ₋₍ᵢ₋₁₎ₜₕ+0.02E(z)ₒᵤₜ₋₍ᵢ₋₁₎ₜₕ

The iteration is terminated when the difference of each step along the band is lower than 0.5 meV in STO and 1 meV in LAO between two successive iterations. The well depth, defined as the length from the interface to where E_{F} (dashed line) intersects with the conduction band, is about 7 nm and tightly confined to the interface. The confinement could be ascribed to the low permittivity controlled by the strong local field at the interface. Results of the P—S calculations are shown in FIG. 2(d).

STO and Comparison With 10 u.c. LAO/STO; Dependence on Incident Intensity

Photoluminescence spectra from 4.2K<T<300K were also collected from STO single-crystal substrates under the same conditions as those for the 10 u.c. LAO/STO: pristine bare STO and STO samples that have undergone all of the annealing steps prior to the typical LAO film growth, and from substrates exposed to water vapor (FIG. 3, bottom). Both the bare STO and the treated STO sample showed the broad photoluminescence feature similar to those shown in FIGS. 1(c) and (d). However, in the 4.2K photoluminescence spectrum from TiO₂-terminated STO exposed to water vapor resulting in H⁺-chemisorption, the lower-energy broad blue PL is also suppressed, and sharp UV features are observed, similar to those that are seen in the 10 u.c. LAO/STO samples. However, the photoluminescence intensity from treated STO is seen to be approximately two orders of magnitude weaker than from LAO/STO.

### REFERENCES

[1] A. Ohtomo and H. Y. Hwang, Nature 427, 423 (2004), URL http://dx.doi.org/10.1038/nature02308.

[2] E. Dagotto, Science 309, 257 (2005).

[3] N. Reyren, S. Thiel, A. D. Caviglia, L. F. Kourkoutis, G. Hammerl, C. Richter, C. W. Schneider, T. Kopp, A.-S. Retschi, D. Jaccard, et al., Science 317, 1196 (2007).

[4] J. A. Bert, B. Kalisky, C. Bell, M. Kim, Y. Hikita, H. Y. Hwang, and K. A. Moler, Nat Phys 7, 767 (2011), URL http://dx.doi.org/10.1038/nphys2079.

[5] L. Li, C. Richter, J. Mannhart, and R. C. Ashoori, Nat Phys 7, 762 (2011), URL http://dx.doi.org/10.1038/nphys2080.

[6] C. Cen, S. Thiel, G. Hammerl, C. W. Schneider, K. E. Andersen, C. S. Hellberg, J. Mannhart, and J. Levy, Nature Materials 7, 298 (2010).

[7] P. Irvin, Y. J. May, D. F. Bogorin, and J. Levy, Nature Photonics 4, 849 (2010).

[8] C. Cen, S. Thiel, J. Mannhart, and J. Levy, Science 323, 1026 (2009).

[9] M. Breitschaft, V. Tinkl, N. Pavlenko, S. Paetel, C. Richter, J. R. Kirtley, Y. C. Liao, G. Hammerl, V. Eyert, T. Kopp, et al., Phys. Rev. B 81, 153414 (2010), URL http://link.aps.org/doi/10.1103/PhysRevB.81.153414.

[10] R. Arras, V. G. Ruiz, W. E. Pickett, and R. Pentcheva, Phys. Rev. B 85, 125404 (2012), URL http://link.aps.org/doi/10.1103/PhysRevB.85.125404.

[11] N. Y. Chan, M. Zhao, N. Wang, K. Au, J. Wang, L. W. H. Chan, and J. Dai, ACS Nano 7, 86738679 (2013).

[12] Y. Li and J. Yu, Journal of Physics: Condensed Matter 25, 265004 (2013), URL http://stacks.iop.org/0953-8984/25/i=26/a=265004.

[13] Y. Xie, Y. Hikita, C. Bell, and H. Y. Hwang, Nat. Commun 2, 767 (2011), URL http://dx.doi.org/10.1038/ncomms1501.

[14] F. Li, M. Liang, W. Du, M. Wang, Y. Feng, Z. Hu, L. Zhang, and E. G. Wang, Applied Physics Letters 101, 251605 (pages 4) (2012), URL http://link.aip.org/link/?APL/101/251605/1.

[15] S. Mochizuki, F. Fujishiro, and S. Minami, J. Phys. Condens. Matter 17, 923 (2005), URL http://iopscience.iop.org/0953-8984/17/6/011/.

[16] A. Kalabukhov, R. Gunnarsson, J. Börjesson, E. Olsson, T. Claeson, and D. Winkler, Phys. Rev. B 75, 121404 (2007), URL http://link.aps.org/doi/10.1103/PhysRevB.75.121404.

[17] A. E. Souza, G. T. A. Santos, B. C. Barra, W. D. Macedo, S. R. Teixeira, C. M. Santos, A. M. O. R. Senos, L. Amaral, and E. Longo, Crystal Growth Design 12, 5671 (2012), URL

http://pubs.acs.org/doi/abs/10.1021/cg301168k.

[18] Y. Yamada and Y. Kanemitsu, Phys. Rev. B 82, 121103 (2010), URL http://link.aps.org/doi/10.1103/PhysRevB.82.121103.

[19] F. Gervais, J.-L. Servoin, A. Baratoff, J. G. Bednorz, and G. Binnig, Phys. Rev. B 47, 8187 (1993).

[20] Neville, B. Hoeneisen, and C. A. Mead, Journal of Applied Physics 43, 2124 (1972), URL http://link.aip.org/link/?JAP/43/2124/1.

[21] V. M. Longo, A. T. de Figueiredo, S. de L'azaro, M. F. Gurgel, M. G. S. Costa, C. O. Paiva-Santos, J. A. Varela, E. Longo, V. R. Mastelaro, F. S. D. Vicente, et al., Journal of Applied Physics 104, 023515 (pages 11) (2008), URL http://link.aip.org/link/?JAP/104/023515/1.

[22] V. M. Longo, M. das Graca Sampaio Costa, A. Zirpole Simoes, I. L. V. Rosa, C. O. P. Santos, J. Andres, E. Longo, and J. A. Varela, Phys. Chem. Chem. Phys. 12, 7566 (2010), URL http://dx.doi.org/10.1039/B923281

[23] H. E. Orhan, F. M. Pontes, C. D. Pinheiro, T. M. Boschi, E. R. Leite, P. S. Pizani, A. Beltrn, J. An-drs, J. A. Varela, and E. Longo, Journal of Solid State Chemistry 177, 3879 (2004), ISSN 0022-4596, URL http://www.sciencedirect.com/science/article/pii/S0022459604004244.

[24] S. Zollner, A. A. Demkov, R. Liu, P. L. Fejes, R. B. Gregory, P. Alluri, J. A. Curless, Z. Yu, J. Ramdani, R. Droopad, et al. (AVS, 2000), vol. 18, pp. 2242-2254, URL http://link.aip.org/link/?JVB/18/2242/1.

[25] F. Bi, D. F. Bogorin, C. Cen, C. W. Bark, J.-W. Park, C.-B. Eom, and J. Levy, Applied Physics Letters 97, 173110 (pages 3) (2010), URL http://link.aip.org/link/?APL/97/173110/1.

[26] W. joon Son, E. Cho, J. Lee, and S. Han, Journal of Physics: Condensed Matter 22, 315501 (1993), URL http://link.aps.org/doi/10.1103/PhysRevB.47.8187.

[27] V. I. Anisimov, F. Aryasetiawan, and A. I. Lichtenstein, Journal of Physics: Condensed Matter 9, 767 (1997), URL http://stacks.iop.org/0953-8984/9/i=4/a=002.

[28] P. D. C. King, T. D. Veal, and C. F. McConville, Phys. Rev. B 77, 125305 (2008), URL http://link.aps.org/doi/10.1103/PhysRevB.77.125305. 13

[29] J. Biscaras, N. Bergeal, S. Hurand, C. Grossetete, A. Rastogi, R. C. Budhani, D. LeBoeuf, C. Proust, and J. Lesueur, Phys. Rev. Lett. 108, 247004 (2012), URL http://link.aps.org/doi/10.1103/PhysRevLett.108.247004.

[30] J. P. Bergman, T. Lundström, B. Monemar, H. Amano, and I. Akasaki, Applied Physics Letters 69, 3456 (1996), URL http://link.aip.org/link/?APL/69/3456/1.

[31] B. Shen, T. Someya, O. Moriwaki, and Y. Arakawa, Applied Physics Letters 76, 679 (2000), URL http://link.aip.org/link/?APL/76/679/1.

[32] Y. Luo, J. Wan, Y. Yeh, and K. Wang, Journal of Electronic Materials 30, 459 (2001).

[33] Y. Yamada and Y. Kanemitsu, Phys. Rev. B Rapid Communications 82, 121103 (2010).

[34] W. Meevasana, P. D. C. King, R. H. He, S.-K. Mo, M. Hashimoto, A. Tamai, P. Songsiriritthigul, F. Baumberger, and Z.-X. Shen, Nat Mater 10, 114 (2011), URL http://dx.doi.org/10.1038/nmat2943.

[35] N. Breckenfeld, N. Bronn, A. R. Damodaran, S. Lee, N. Mason, and L. W. Martin, Phys. Rev. Lett. 110, 196804 (2013).

[36] J. P. Perdew and Y. Wang, Phys. Rev. B 45, 13244 (1992).

[37] V. I. Anisimov, F. Aryasetiawan, and A. I. Lichtenstein, Journal of Physics: Condensed Matter 9, 767 (1997).

[38] P. Giannozzi, S. Baroni, N. Bonini, M. Calandra, R. Car, C. Cavazzoni, D. Ceresoli, G. L. Chiarotti, M. Cococcioni, I. Dabo, et al., Journal of Physics: Condensed Matter 21, 395502 (2009).

[39] M. Cococcioni and S. de Gironcoli, Phys. Rev. B 71, 035105 (2005).

[40] A. M. Rappe, K. M. Rabe, E. Kaxiras, and J. D. Joannopoulos, Phys. Rev. B Rapid Comm. 41, 1227 (1990).

[41] N. J. Ramer and A. M. Rappe, Phys. Rev. B 59, 12471 (1999).

[42] http://opium.sourceforge.net.

[43] H. J. Monkhorst and J. D. Pack, Phys. Rev. B 13, 5188 (1976).

[44] F. Bi, D. F. Bogorin, C. Cen, C. W. Bark, J.-W. Park, C.-B. Eom, and J. Levy, Applied Physics Letters 97, 173110 (pages 3) (2010).

[45] S. L. Dudarev, G. A. Botton, S. Y. Savrasov, C. J. Humphreys, and A. P. Sutton, Phys. Rev. B 57, 1505 (1998).

[46] E. Dagotto, Science 309, 257 (2005).

[47] A. Ohtomo and H. Y. Hwang, Nature 427, 423 (2004).

[48] N. Reyren, S. Thiel, A. D. Caviglia, L. F. Kourkoutis, G. Hammerl, C. Richter, C. W. Schneider, T. Kopp, A.-S. Retschi, D. Jaccard, et al., 317, 1196 (2007).

[49] S. Thiel, G. Hammerl, A. Schmehl, C. W. Schneider, and J. Mannhart, Science 313, 1942 (2006).

[50] P. D. C. King, T. D. Veal, and C. F. McConville, Phys. Rev. B 77, 125305 (2008).

[51] J. Biscaras, N. Bergeal, S. Hurand, C. Grosset̂ete, A. Rastogi, R. C. Budhani, D. LeBoeuf, C. Proust, and J. Lesueur, Phys. Rev. Lett. 108, 247004 (2012).

[52] S. Su, J. H. You, and C. Lee, Journal of Applied Physics 113, 093709 (2013).

[53] J. M. Blatt, Journal of Computational Physics 1, 382 (1967), ISSN 0021-9991.

[54] R. Pentcheva and W. E. Pickett, Phys. Rev. B 78, 205106 (2008).

[55] A. F. Santander-Syro, O. Copie, T. Kondo, F. Fortuna, S. Pailhes, R. Weht, X. G. Qiu, F. Bertran, A. Nicolaou, A. Taleb-Ibrahimi, et al., Nature 469, 189 (2011).

[56] R. Pentcheva, M. Huijben, K. Otte, W. E. Pickett, J. E. Kleibeuker, J. Huijben, H. Boschker, D. Kockmann, W. Siemons, G. Koster, et al., Phys. Rev. Lett. 104, 166804 (2010).

[57] R. C. Neville, B. Hoeneisen, and C. A. Mead, Journal of Applied Physics 43, 2124 (1972).

What is claimed:

1. A system for detection of a chemical species comprising:
a complex oxide heterostructure comprising an upper member having an exposed surface, a lower member, and an interface between the upper and lower members,
wherein chemisorption of said chemical species at the exposed surface of the upper member produces ultraviolet photoluminescence at the interface between the upper and lower members, and
wherein said upper member has a thickness of up to about 30 unit cells; and,
a sensor for determining the absence or presence of ultraviolet photoluminescence at the interface.

2. The system according to claim 1, wherein said chemical species is characterized as donating up to one-half electron per unit cell of said upper member when chemisorbed onto the exposed surface of said upper member.

3. The system according to claim 1, wherein said chemical species is characterized as filling an oxygen vacancy on the exposed surface of said upper member.

4. The system according to claim 1, wherein said chemical species is a molecule containing an alkali or transition metal and at least one cation that results in chemisorption of H+ on the exposed surface of said upper member.

5. The system according to claim 1, wherein said upper and lower members comprise an oxide perovskite.

6. The system according to claim 1, wherein said upper member comprises GdTiO₃, SrVO₃, LaVO₃, SrNbO₃, or LaAlO₃ and said lower member comprises SrTiO₃.

7. The system according to claim 1, wherein said sensor measures the intensity of said ultraviolet photoluminescence, measures the chemisorption coverage on a surface of the upper layer, or both.

8. A method for determining the absence or presence of a chemical species in a sample comprising:
providing a complex oxide heterostructure comprising an upper member having an exposed surface, a lower member, and an interface between the upper and lower members,
wherein chemisorption of said chemical species at the exposed surface of the upper member produces ultraviolet photoluminescence at the interface between the upper and lower members, and
wherein said upper member has a thickness of up to about 30 unit cells;
contacting the exposed surface of the upper member of said heterostructure with the sample;
and,
determining whether the interface between the upper and lower members produces ultraviolet photoluminescence following said contacting step.

9. The method according to claim 8, further comprising measuring the intensity of any ultraviolet photoluminescence at the interface between the upper and lower members.

10. The method according to claim 8, further comprising, if said interface does produce ultraviolet photoluminescence, terminating at least some of said ultraviolet photoluminescence.

11. The method according to claim 10, wherein said photoluminescence is terminated using one or more of a laser, a heat pulse, or photoionization.

12. An optoelectronic device comprising:
a complex oxide heterostructure comprising an upper member having an exposed surface, a lower member, and an interface between the upper and lower members,
wherein said upper member has a thickness of up to about 30 unit cells; and,
a plurality of individual members of a chemical species that is chemisorbed in a patterned array on said exposed surface of the upper member, wherein the chemisorption of each member of said chemical species at the exposed surface produces ultraviolet photoluminescence at a location of the interface that corresponds to the spatial location of each member on said exposed surface.

13. A plurality of optoelectronic devices according to claim 12 that encodes information when said ultraviolet photoluminescence at the interface of each respective device is read in series.

14. A method for producing an optoelectronic device comprising:
providing a complex oxide heterostructure comprising an upper member having an exposed surface, a lower member, and an interface between the upper and lower members,
wherein said upper member has a thickness of up to about 30 unit cells;
chemisorbing a plurality of individual members of a chemical species in a patterned array on said exposed surface of the upper member,
wherein the chemisorption of a member of said chemical species at the exposed surface produces ultraviolet photoluminescence at a location of the interface that corresponds to the spatial location of said member on said exposed surface.

15. The method according to claim 14, further comprising chemisorbing at least one member of each of two different chemical species, wherein the chemical species respectively produce different intensities of ultraviolet photoluminescence at said interface when chemisorbed onto the exposed surface of the upper member.

16. The method according to claim 14, further comprising providing a plurality of said optoelectronic devices that encode information when said ultraviolet photoluminescence at the interface of each respective device is read in series.
